(19) United States
(12) Patent Application Publication
(10) Pub. No.: US 2005/0035849 A1
(43) Pub. Date: Feb. 17, 2005

(54) Method and system for inventory count of articles with RFID tags

(76) Inventor: Yadgar Yizhack, Rasnana (IL)

Correspondence Address: KATTEN MUCHIN ZAVIS ROSENMAN, 575 MADISON AVENUE, NEW YORK, NY, 10022-2585, US

(21) Appl. No.: 10/639,604

(22) Filed: Aug. 12, 2003

(51) Int. Cl. H04Q 1/00

(52) U.S. Cl. 340/5.92; 340/10.2; 235/385

(57) ABSTRACT

The present invention discloses a method for counting objects within defined area, using tag transceivers attached to each object and interrogating transmitters scattered at different places within the defined area. Each counting cycle is differentiated and identified and the tags avoid responding duplicate interrogation counting requests of the same identified counting cycle. The present invention improves the counting cycle by controlling data traffic transmission by dynamically changing the tags transmission probability parameter as a function of overall uncounted number of tags at each interrogation session. The present invention discloses a new transmission protocol for collisions' identification. Such protocol applies any modulating technique for the transmitted messages header, wherein the response transmissions are synchronized and include identical headers for identifying all received signals including corrupted signals.

### BACKGROUND OF THE INVENTION

The present invention relates to the field of inventory counting systems, and particularly to systems using RFID tags. Most inventory systems are currently based on periodical manual inventory count with continuous update of incoming and outgoing items. This process may be slow and inefficient, as well as labor and time consuming. Therefore there have been systems suggested to replace manual inventory counts with an automatic system.

U.S. Pat. No. 6,195,006 describes a system in which every item has a unique code, and the movement of items in and out of a relevant area is monitored and controlled through the use of RFID tags. Various problems arise regarding the use of such a system. Several solutions to these problems have been suggested, as disclosed in patents described herein.

US patent applications 20020175805 and 20020063622 deal with the problem of collisions of transmissions broadcasted from multiple RFID tags at the same time. Their method suggested in order to reduce collisions is to limit the number of responses from RFID tags through an interrogation protocol. This method will indeed reduce the number of collisions, yet it will greatly increase the amount of time required for a counting cycle, namely it will greatly reduce the efficiency. Another patent, U.S. Pat. No. 6,154,136, suggests reducing the number of collisions by increasing the intervals of inter transmission between responses. The collision problem is also addressed by U.S. Pat. Nos. 6,265,962, 5,986,570 and 6,091,319 and the ideas behind all three patents are methods of notifying the RFID tags that a collision has occurred and thus they must retransmit. The system proposed by said patents will not reduce the number collisions, and may even increase it due to the amount of retransmissions.

Another solution is suggested in patent No. 6,377,203, using multiple transmission channels protocols for avoiding collision by diverting tag transmissions.

Another important aspect, which is addressed by few patents, is power management of RFID tags. The tags receive their energy through the interrogating processes from the interrogating station. U.S. Pat. No. 5,621,412 disclose energy management systems in which RFID tags are awakened at certain energy levels through the interrogating processes by the interrogating station. The tags are activated only if received sufficient energy. U.S. Pat. No. 5,945,920 disclose RFID tags, which operate different write operation at different voltage levels.

Although these solutions enable more effective energy management the tags effective transmission range remains the same.

None of the patents or applications mentioned above, disclose an inventory counting system, which enables to perform an effective interrogation counting process within an active environment in which items are moved internally and externally. It is thus the prime object of the invention to create a highly efficient and energy managed automatic inventory counting system, which is able to provide nearly real-time status information of the inventory in various stages of its life under continuously dynamically changing conditions.

### SUMMARY OF THE INVENTION

The present invention discloses a method for counting objects within defined area, using tag transceivers attached to each object and interrogating transmitters scattered at different places within the defined area. Each counting cycle is differentiated and identified and the tags avoid responding duplicate interrogation counting requests of the same identified counting cycle.

The counting cycle is optionally identified by a serial number, which is embedded within each interrogation request and recorded in each tag once the tag received acknowledgment for its respond.

According to present invention it is further suggested to control data traffic transmission by dynamically changing a transmission probability parameter as a function of overall uncounted number of tags at each interrogation session.

The probability parameter determines the probability of each tag to transmit at a given period.

For improving the interrogation process, the present invention discloses a new transmission protocol for collisions' identification. Such protocol applies any modulating technique for the transmitted messages header, wherein the response transmissions are synchronized and include identical headers for identifying all received signals including corrupted signals.

For more efficient energy management of the passive tags it is suggested to use at least two energy levels for charging passive tags, wherein the lower energy level is for communication and the higher energy level is for charging energy, enabling the tag to communicate and be synchronized with distance interrogating stations.

For more efficient energy management of the active tags it is suggested to use at least three energy levels for operating the tags, wherein the higher energy level is used for awakening the active tag, the lower energy level is used for charging the active tag and the third level for communication.

For improving the interrogation process within conductive obstructed environment it is suggested to use multiple transmission frequencies, wherein lower transmission frequencies are used for interrogating tags of marginal RF coverage.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1 is a schematic illustration of environment in which the present invention is practiced;

FIG. 2 is a flowchart representation of inventory counting process implementing cycle counting identification method in accordance with the principles of the present invention;

FIG. 3 is flowchart representation of the of inventory counting process implementing tag transmission control in accordance with the principles of the present invention;

FIG. 4 is flowchart representation collision detection, in accordance with the principles of the present invention;

FIG. 5 is a chart illustrating the collision of three header signals;

FIG. 6 is flowchart representation of energy management of passive tags, in accordance with the principles of the present invention;

FIG. 7 is flowchart representation of energy management of battery operated tags, in accordance with the principles of the present invention;

FIG. 8 is flowchart representation of Dual frequency interrogation process in accordance with the principles of the present invention;

### DETAILED DESCRIPTION OF THE PREFERRED EMBODIMENTS

The embodiments of the invention described herein are transmission protocols and algorithms implemented within an inventory counting system.

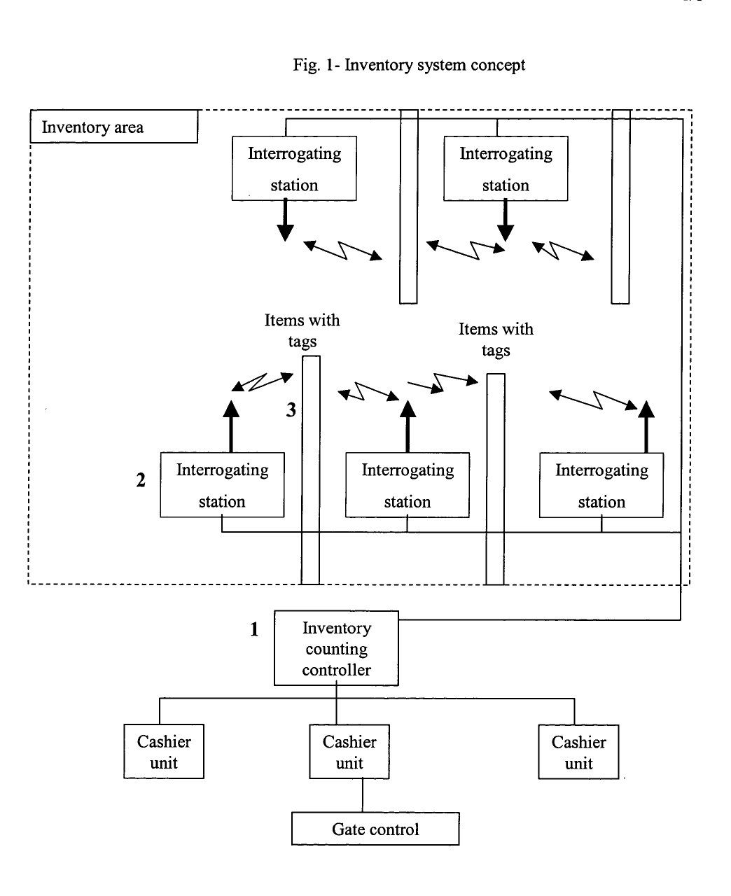

FIG. 1 describes the environment of such a system, which can take the form of a supermarket, a department store or any warehouse with inventory spread on shelves throughout a large floor(s). Three basic components of the system are: an inventory counting controller with a counting application program, a number of interrogating stations, and a number of RFID tags.

The inventory counting controller computer station/server, as suggested by present invention comprises a new supervising module implemented therein for managing all interrogating stations. This supervising module includes new features and algorithms for improving the interrogation process as further described in the embodiments described below.

The interrogating stations are “smart” radio transceivers' terminal stations, which are situated in strategic locations on the shop/warehouse floor in order to get the best radio coverage between the interrogating stations and RFID tags spread in the area. Each station covers an area of multiple, various, items, and performs the counting of these items. This action can be performed by all of the interrogating stations at the same period. The interrogation procedure can be performed for reasons other then counting, such as performing a query search.

The RFID tags are attached to each item in the area of coverage. There might be areas in which items are within the range of more then one station, and the system is designed to avoid recounting such objects. Additionally, dynamic activities in the store, warehouse, or other relevant areas in which the system is utilized, do not influence ongoing performance of the counting system, as specified hereinafter. Thus, items may be moved, new items may be added and items may be removed during the interrogation. The system always provides a complete inventory that is up-to-date, according to the latest completed counting process. The system performs a time adaptive counting cycle of unknown items in minimal time periods and can handle a considerably significant amount of items.

[ ]

The present invention offers the following new features that offer several advantages over existing inventory counting systems:
1. Improvements regarding dynamic inventory counting process: Preventing duplicate counting and increasing the process reliability and effectiveness through counting cycle identification and tag identification;
2. Using adaptable transmission probability for improving the reliability and effectiveness of the counting process. Maximize channel throughput and minimizing collisions
3. Detecting collisions occurrence;
4. Passive tag energy management;
5. Active tag energy management;
6. Dual frequency interrogation process;

1. Prevention of Duplicate Counting Through (Counting) Cycle and Tag Identification

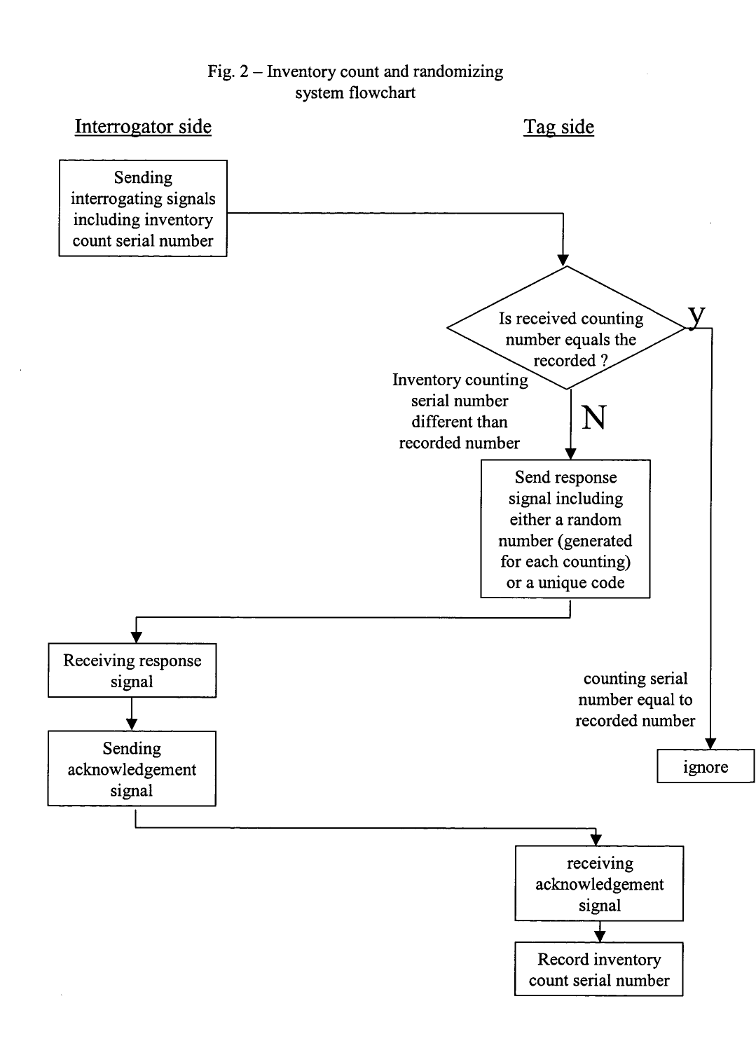

FIG. 2 describes the method which is used by the RFID tags in order to keep in track with the current inventory count cycle during the process of interrogation. Each inventory count cycle has an identifying serial number. This number is transmitted along with every interrogation transmission and if the tag is counted, the number is recorded within the tag's memory. The inventory count cycle serial number is changed from one inventory count cycle to the next (while cycle numbers are not necessarily consecutive). Each tag ignores the interrogation if it identifies that the counting cycle's serial number matches the recorded number in the tag memory, hence, once an item has been counted, it will not respond to any additional counting cycle. Due to this feature, the probability of receiving duplicate responds during a counting cycle is reduced to minimum. As this feature decreases the number of the tags transmissions, the whole counting cycle period shortened.

If an inventory count cycle's serial number is different from the recorded number, that is to imply a new counting cycle for the tag, the tag activates itself and sends a response to the station. This response includes either a random number associated with the current count or a predefined unique number. The random number is long enough in order to reduce the probability of having two identical tag numbers during the same inventory count cycle. The random number's length is proportional to the required accuracy level from the system.

After receiving a response signal from a tag, the station will verify the tag, and send the tag an acknowledgment signal. Only upon receiving this signal will the tag record the new inventory count cycle serial number. Upon completion of the cycle, the system will determine a new cycle serial number, which will be based on the previous cycle serial number with a change of one or more bits. This algorithm will maintain the energy expense of writing into the tag memory, reducing it to a minimum.

In addition to cycle identification, counting duplication is prevented by tag identification. Tag identification number is achieved either by generating of a random number by the tag or using a pre-assigned unique number. The inventory counting controller records each tag number (whether randomized or unique) and uses this information to ensure that the item is not recounted. This procedure of identifying tags is aimed at avoiding situations whereby the tag responds more than once in a cycle when an acknowledgement signal is not received by the tag. Thus the tag may respond a number of times but is counted only once.

When inventory count is synchronized to the end of the cycle, new items that are brought to the floor during the counting cycle are also counted, as the interrogation is a continuous process. (The counting is preformed using sub cycles. Each sub cycle is shorter from the previous one, as the uncounted items usually decreases. Hence, at the time of performing the latest sub cycles, which are very short, the chance of that new activities will occur during the sub cycle is almost zero, optionally the system may be defined so as not to allow the addition of new items during the last sub cycle). Items that were counted and sold during the counting cycle, will be discarded from the inventory at the cashier stations.

Where the inventory is synchronized to the beginning of the cycle, it is not allowed to add-in items during the counting cycle. Items that are sold and not counted are added to the inventory when passing the cashier and items that were moved will be counted by another station during additional sub cycles.

According to an alternative procedure suggested by the present invention, the counting cycle termination is determined by sending special codes at the end of each cycle, or according to a predefined time period.

2. Using Adaptable Transmission Probability for Improving the Reliability and Effectiveness of the Counting Process. Maximize Channel Throughput and Minimizing Collisions

Adaptable transmission probability improves the reliability and effectiveness of the counting process.

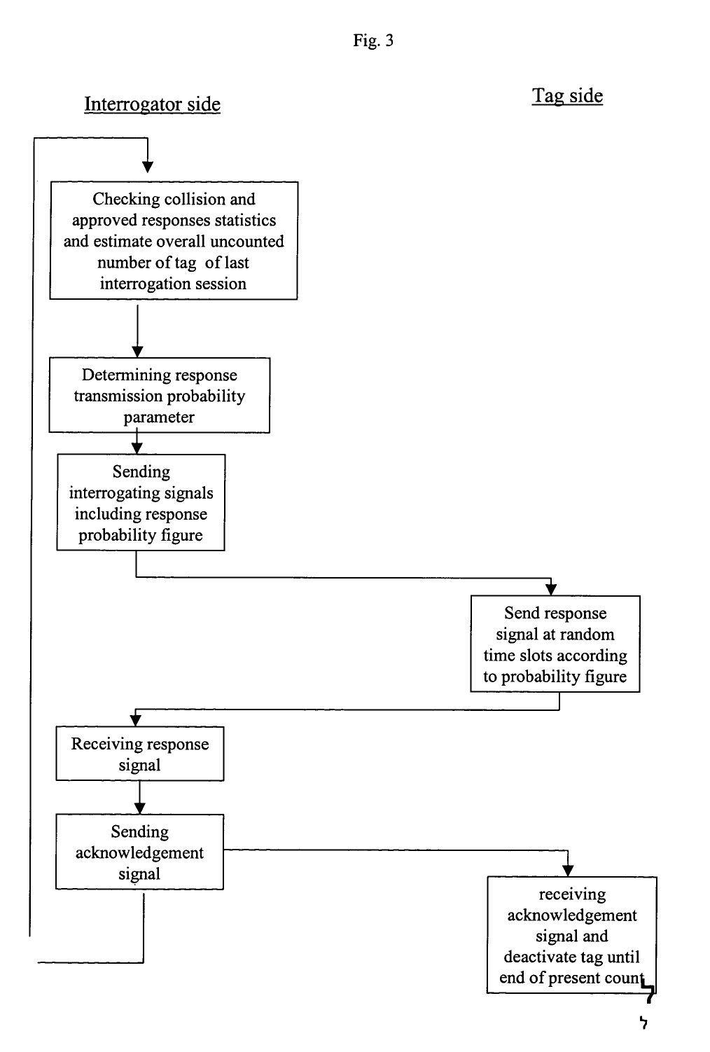

FIG. 3 illustrates the process of data flow between the interrogating stations and RFID tags, and the communication protocol, which is based on the calculated statistics gathered during the counting cycle. This process, as suggested by the present invention, achieves shorter interrogation cycles with minimum collisions and is therefore more efficient that the processes disclosed in previous patents. The key parameter in this process of data flow P is the probability to transmit at specific time window (a figure between 0 and 1). This parameter controls the data traffic transmission. It is calculated before every interrogation cycle and is transmitted to the tags along with the interrogating request. When the number of uncounted tags is large, the interrogating station issues a low probability figure, and as the number of remaining uncounted tags is reduced, the interrogation station would issue a higher probability figure.

This is an iterative process, based on calculation of the number of the remaining uncounted tags. The calculation is based on an estimation of the previous number of transmitting tags, which is determined according to the number of overall received number of tag signals and identified collisions. Each tag that receives the interrogating request makes statistic calculations determining whether it should respond, said calculations are based on the received P figure. The tag responds within a specific time window according to figure P at a randomly selected time slot within the time window. (Dividing the window into time slots increase the channel throughput). A collision will occur when two (or more) tags respond within the same time slot. P can be updated in every interrogation cycle until P=1 and there are no more responses. Tags that respond correctly are acknowledged by the interrogating station and will not respond again within the current inventory counting cycle. As a result, in the next interrogations there are less uncounted tags and p can be increased. Once P=1 and there are no more responses, the interrogator identifies that the sub cycle has ended and a new counting process may be initiated.

As a result, the number of items, which can be handled by the present invention, is significantly larger than in existing systems, whereas the period of time required for completing an inventory counting procedure is relatively short. At warehouse environment wherein the number of tags is unknown, the present invention has a significant advantage over prior art systems which use constant transmission probability and thereby are optimized only for a target number of tags.

3. Detecting Collision Occurrences

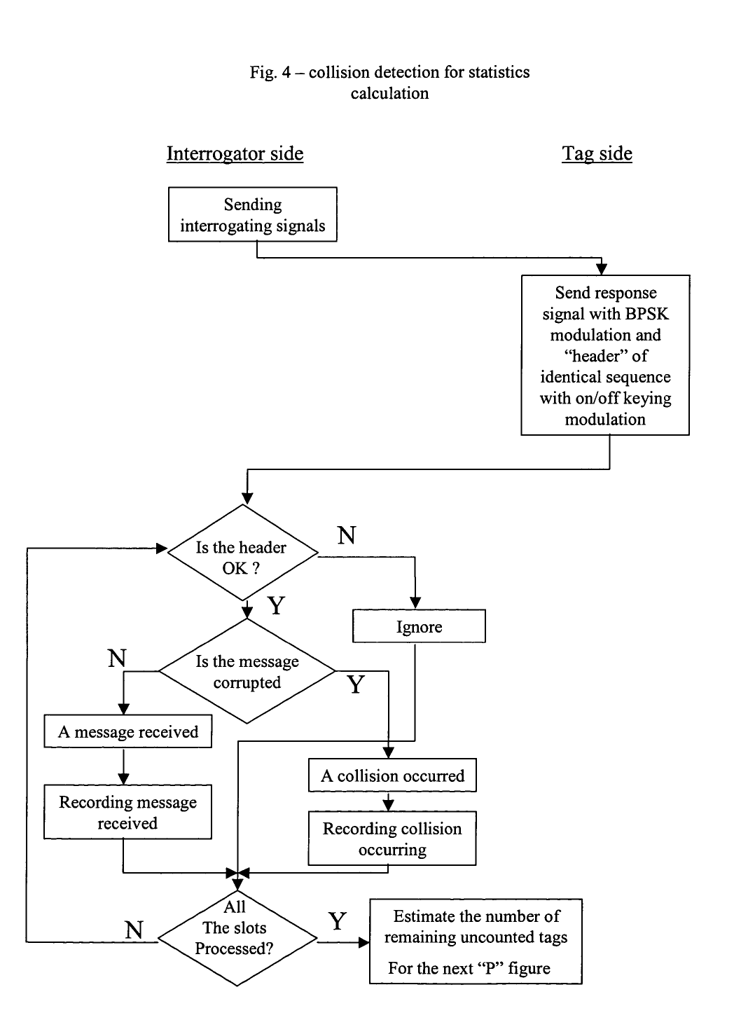

FIG. 4 describes the method of detecting collisions by the interrogating station. When a collision occurs, it is may difficult to detect that a corrupted signal was received.

It is thus necessary firstly to detect an arrival of a corrupted signal and only afterwards to identify the collision event.

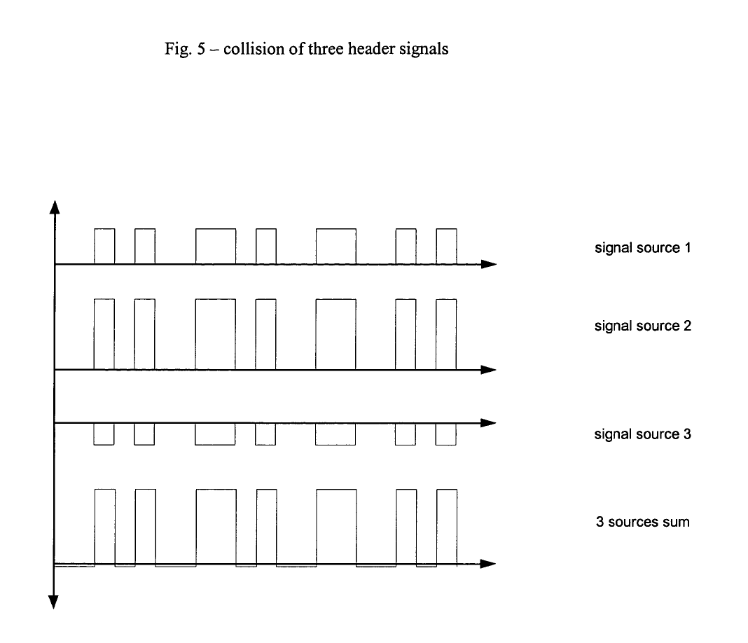

For detection of an arrival of a corrupted signal, it is suggested to use two modulation techniques as follows: the BPSK (alternatively can be MSK, OOK or any other known mutilation scheme) RF modulation technique for transmitting the signal's data section and ON/OFF keying for transmitting the signal's header section. It is proposed to use an identical header for all transmitted messages. The response data received from each tag includes the header followed by the relevant data, ending with the proper CRC (Code Redundancy Check). The header is identical for all tags and is time synchronized with the interrogating stations. Since all tags are synchronized with the interrogating station, two or more tags will transmit the same sequence header at the same time in a collision situation. When the interrogating station receives the header from more then one tag, there is a very high chance that it will detect the header even if there is a change of RF level reception (as seen in FIG. 5).

It is further suggested to utilize multi path and diversity methodologies for improving the interrogation process. Transmission signal of tags, which include identical header, may be regarded by the interrogator, as multi path signals, hence interrogator incorporating antenna diversity techniques (comprising two or more antennas) can utilize diversity techniques, thus improving the chances of detecting the signals headers.

Once the header signal is detected, and the CRC, parity check, FEC or other error detection methods indicate that the message is corrupted, it is assumed as collision event. As previously indicated in FIG. 2, detection of collisions is one of the factors used in the process of estimating the number of uncounted remaining tags for calculating the new P.

4. Passive Tag Energy Management

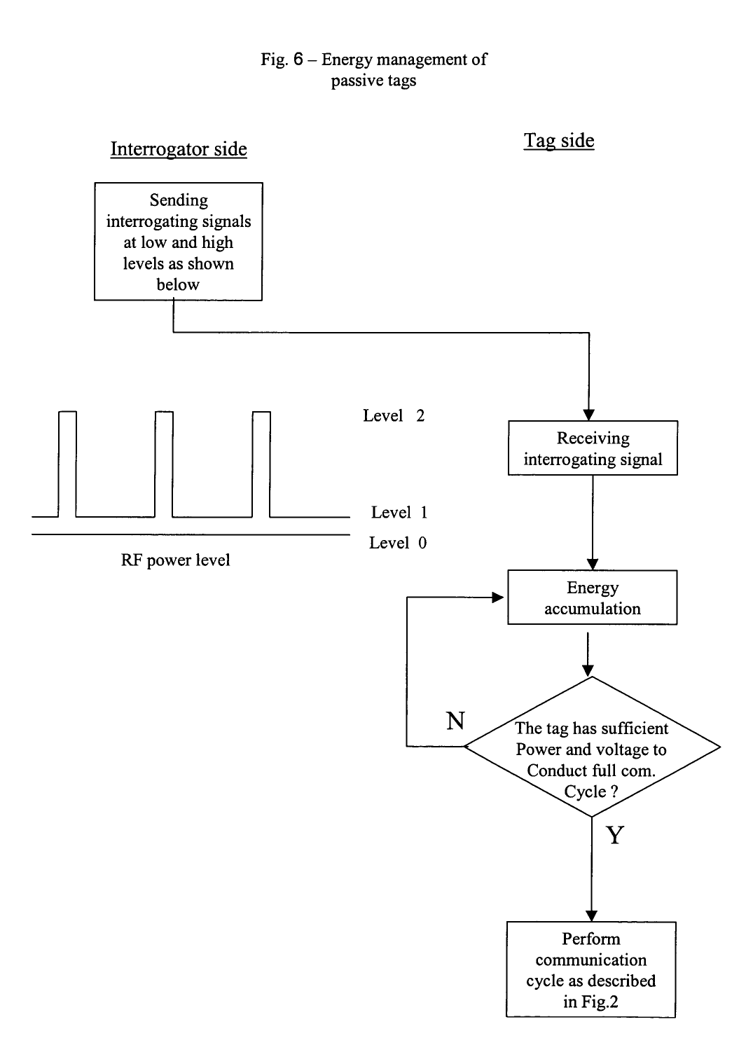

FIG. 6 describes the energy management scheme for passive RFID tags. The system is based on the premise that a passive tag does not respond when it lacks the power to do so. The tag accumulates energy from the continuous RF transmission with the interrogating station. The transmission is performed at two RF levels, each level is limited according to radio transmission standards. The lower level is used for ordinary passive tag communication. The higher level is the charging level, which charges the tag to the proper voltage and energy level. The effective range of passive tags is limited according to the energy and power supply (in our case a capacitor) voltage. Energy can be obtained by accumulation. Voltage can be obtained by pick transmission pulses. As a result, the pick transmission pulses enable energy accumulation increasing the passive tags effective range. The pick transmission can be also used for synchronizing the data clock of the RFID tags.

Once the tag has reached the proper energy level, enabling it to switch to active state and/or to communicate with distant interrogating stations, it will perform tasks as described in FIG. 2 in order to complete the inventory count cycle (active operations). Thus, the second level transmission enables charging a passive tag from a distant station, which may lengthen the time required to complete an inventory count cycle, but will enable use of passive tags.

5. Active Tag Energy Management

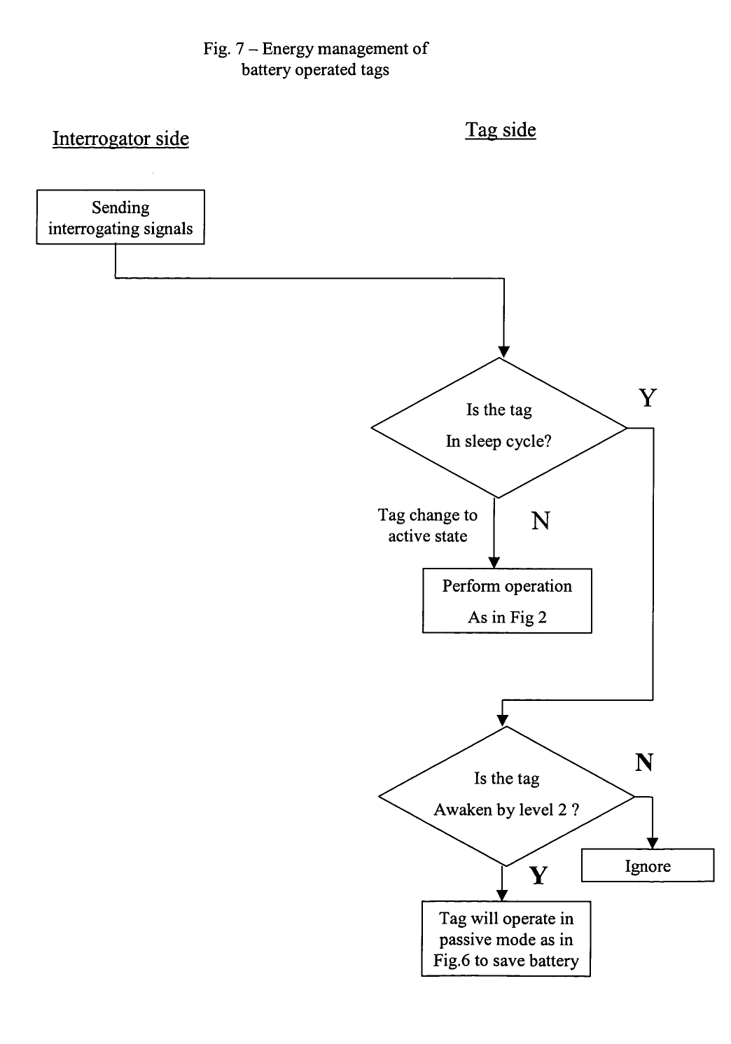

FIG. 7 describes the energy management system of battery-operated RFID tags. The objective of this system is to conserve the battery's energy for a prolonged period of time. This may be achieved by creating a sleeping cycle and activating the tags for only a fraction of this cycle. The activation time will be sufficient for the tag to receive the interrogation signal. The interrogating station can change the sleeping cycle in accordance with the status of the inventory. Almost every inventory item will change its inventory status at least once in its lifetime. An item changes its status from a ‘slow moving item’ to a ‘higher moving item’ or vice versa. For example, an item may have a different status when located at a warehouse than its status in a resale store. This status may change the frequency of the inventory count and the item's shelf life.

The sleeping mode associated with the inventory status may be dictated by the interrogating station in such manner that the batteries in an item will last for the longest possible time. The tags require immediate response time at the cashier stand and gate control point, hence a ‘wake-up’ signal is required. Tags located in the vicinity of the same interrogator (in counting mode) may be activated by “communication level” signals, and can thereby operate continuously. As a result, the tags' batteries are discharges more rapidly. In order to avoid this situation, the present invention suggests operating the active tag in passive mode when in vicinity of interrogator in counting mode. When working at passive mode the two energy levels techniques (as described above) can be used, further including a third energy level for awakening the tag to work in a active mode only at check out control points.

The active tag has an additional energy level which activates the tag at gate control point or any situation when fast respond is needed.

6. Dual Frequency Interrogation Process

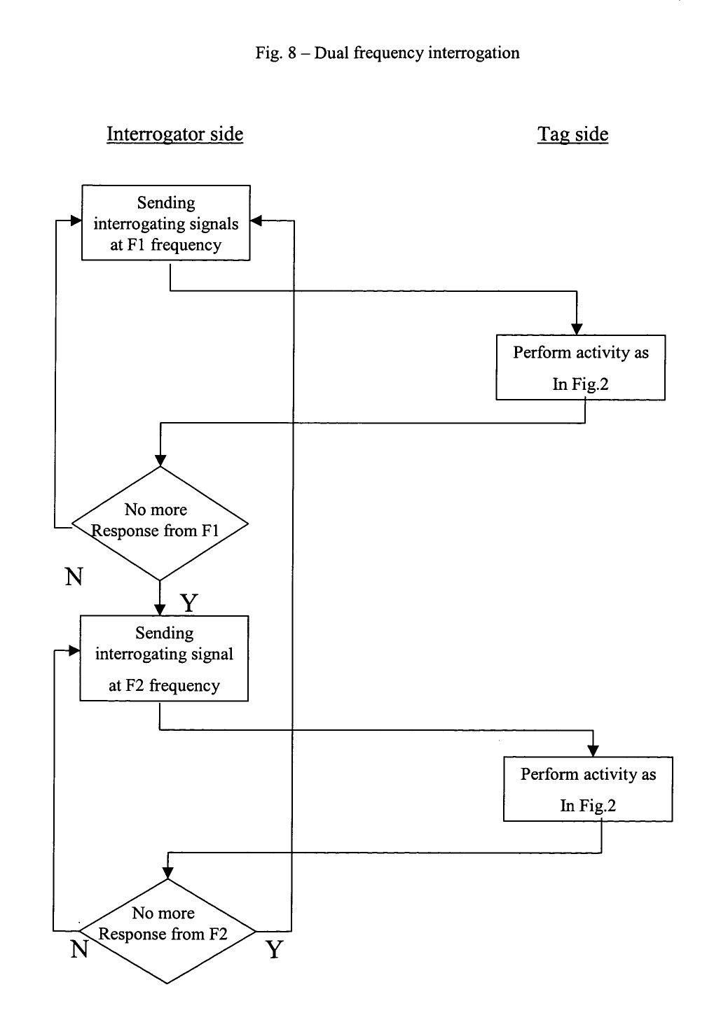

FIG. 8 illustrates the interrogation process for situations in which certain items are covered or packaged by conductive materials which may cause distortion (through reflection) or blockage of the interrogating signals. Such situations may be also caused due to high density or by items which are located deep in the shelves and obstructed by other items. At these situations low frequency RF signals are required for the interrogation process. High frequency RF signal has better communication range in open space where the items have better propagations conditions (direct line of sight or near line of sight) in relation to the interrogator but poor communication range in conductive obstructed environment. It is suggested by the present invention to use multiple frequency transmission signals applying a time division method for the interrogation process. In high density areas, the interrogators or interrogators antenna will be located in short vicinity from the items (i.e. between shelves) to enable communication at a low frequency RF signal. The same interrogators can operate in high frequency signals to communicate with far items, which are positioned in line of sight (or near line of sight) with the interrogator.

1. A method for counting objects within defined area, using tag transceivers attached to each object and interrogating transmitters scattered at different places within the defined area, wherein each counting cycle is differentiated and identified and the tags avoid responding duplicate interrogation counting requests of the same identified counting cycle.

2. The method of claim 1 wherein each counting cycle is identified by a serial number, which is embedded within each interrogation request and recorded in each tag once the tag received acknowledgment for its respond.

3. The method of claim 2 wherein two subsequent counting cycles identifying serial number are differentiated by only one bit.

4. The method of claim 1 wherein each counting cycle is identified according to pre-defined time intervals.

5. The method of claim 1 wherein each counting cycle is identified according to special signals codes indicating of cycle beginning and/or cycle end.

6. The method of claim 1 wherein each tag is identified by serial number for avoiding duplicate counting.

7. The method of claim 6 wherein the tag identifying serial number is changed at each counting cycle according to generated random number.

8. The method of claim 1 wherein the interrogating counting process is preformed in dynamic environment enabling to count in new added objects, count in object moved between interrogation ranges and count out excluded objects during the counting cycle wherein the duration of the interrogating sub cycles decreases throughout the counting process.

9. The method of claim 1 further including the step of controlling data traffic transmission by dynamically changing a transmission probability parameter as a function overall uncounted number of tags at each interrogation session, wherein said probability parameter determines the probability of each tag to transmit at a given period.

10. A method for counting objects within defined area, using tag transceivers attached to each object and interrogating transmitters scattered at different places within the defined area, said method characterized by controlling data traffic transmission by dynamically changing a transmission probability parameter as a function overall uncounted number of tags at each interrogation session, wherein said probability parameter determines the probability of each tag to transmit at a given period.

11. The method of claim 10 wherein the overall uncounted number of tags is estimated as a function of overall number of received transmission.

12. The method of claim 10 wherein the overall uncounted number of tags is estimated as a function of number of transmission collision events and overall number of properly received tag transmissions.

13. The method of claim 11 wherein estimation function is linear.

14. The method of claim 11 wherein estimation function is nonlinear.

15. The method of claims 10 wherein counting process is terminated once the probability parameter is equal to 1.

16. The method of claims 10 wherein the probability parameter is further calculated according to target function which defines the overall number of approved tags transmissions and collisions events

17. The method of claim 11 wherein overall exciting number of tags is known and the estimation of remaining tags is further based on said known number.

18. The method of claim 10 further characterized by a transmission protocol for collisions' identification, said protocol applies any modulating technique for the transmitted messages header, wherein the response transmissions are synchronized and include identical headers for identifying most received signals including corrupted signals.

19. A method for counting objects within a defined area, using tag transceivers attached to each object and interrogating transmitters scattered at different places within said defined area, said method characterized by a transmission protocol for collisions' identification, said protocol applies any modulating technique for the transmitted messages header, wherein the response transmissions are synchronized and include identical headers for identifying most received signals including corrupted signals.

20. The method of claim 19 further utilizing antenna diversity techniques wherein tags signal having identical header can regarded as multi-path signals.

21. The method of claim 19 wherein the corrupted signals are identified by add parity bits to the signal. (CRC)

22. The method of claim 19 wherein the corrupted signals are identified by using error coding techniques.

23. The method of claim 19 wherein on/off keying modulation technique is applied for the message header.

24. The method of claim 19 wherein any offsetting presentation technique is applied to the message data.

25. The method of claim 19 wherein different modulation schemes are used to the signal header and signal data.

26. The method of claim 19 wherein the interrogating station generates pulses enabling tags which contain inaccurate simple clock circuits to achieve accurate clock synchronizing.

27. A method for counting objects within a defined area, using passive tag transceivers attached to each object and interrogating transmitters scattered at different places within said defined area, said method characterized by using at least two energy levels, wherein the lower energy level is for communication and the higher energy level is for charging energy enabling the tag to synchronize and communicate with distance interrogating stations.

28. The method of claim 27 wherein the tags are charged by accumulating pick transmission pulses.

29. The method of claim 27 wherein synchronized pick transmission pulses are utilized for accurate synchronization of simple and inaccurate data clock circuits contained within the tag.

30. A method for counting objects within a defined area, using active tag transceivers attached to each object and interrogating transmitters scattered at different places within said defined area, said method characterized by using at least three energy levels for operating active tags, wherein the higher energy level is used for awakening the active tag, the medium energy level is used for charging and synchronizing the active tag and the lower level for communication.

31. The method of claim 30 wherein, for an efficient activation of the tag within vicinity of the interrogator, the active tag operate as passive tag using at least two energy levels, wherein the lower energy level is for communication and the medium energy level is for charging energy enabling to widen the communication range when working as passive tag.

32. The method of claim 31 wherein the tags are charged by accumulating pick transmission pulses.

33. A method for counting objects within a defined area, using active tag transceivers attached to each object and interrogating transmitters scattered at different places within said defined area, said method characterized by activating the active tags only for periodical time intervals, wherein the continuous interrogating sessions are preformed at the respective (active) time periods.

34. The method of claim 30 wherein the periodical time intervals can be changed according to the life cycle stage of the object, wherein each life cycle stage requires different frequency of inventory counts.

35. A method for counting objects within a defined area, using tag transceivers attached to each object and interrogating transmitters scattered at different places within said defined area, said method characterized by multiple transmission frequencies, wherein lower transmission frequencies are used for interrogating tags through conductive obstructed environment.
